(19) United States
(12) Patent Application Publication
(10) Pub. No.: US 2013/0021472 A1
(43) Pub. Date: Jan. 24, 2013

(54) APPARATUS FOR DETECTING END OF STRIP AND METHOD OF DOING THE SAME

(71) Applicants: Hirohiko Iwase, Tokyo (JP); Yoshiaki Kon, Tokyo (JP); Toshiharu Kubota, Tokyo (JP)

(72) Inventors: Hirohiko Iwase, Tokyo (JP); Yoshiaki Kon, Tokyo (JP); Toshiharu Kubota, Tokyo (JP)

(21) Appl. No.: 13/521,288

(22) PCT Filed: Jul. 21, 2011
(86) PCT No.: PCT/JP2011/066596

§ 371 Date: Jul. 10, 2012

(51) Int. Cl. H04N 7/18

(52) U.S. Cl. 348/142; 348/E07.085

(57) ABSTRACT

The apparatus in accordance with the present invention detects locations of opposite ends of a running strip in a width-wise direction and heights of the ends. The apparatus includes a first light-source irradiating a light onto a lower surface of a strip, a second light-source perpendicularly irradiating a linear light onto an upper surface of the strip, a camera taking a photo of the strip, and a calculation unit calculating locations of opposite ends of the strip in width-wise and height-wise directions thereof, based on an image resulted from a light irradiated from the first light-source and an image resulted from a light irradiated from the second light-source and reflected at the strip.

### FIELD OF THE INVENTION

The invention relates to an apparatus and a method for detecting an end of a strip in width-wise and height-wise directions while the strip is running in a direction with vertical motion.

### BACKGROUND ART

An inspection as to whether patterns are accurately printed onto a surface of a strip (for instance, a sheet such as a film) is carried out, for instance, by causing the strip to run in a direction, taking a photo of the patterns of the strip, and analyzing photographs of the patterns (for instance, by comparing the patterns to reference patterns). Since it is necessary in the inspection to detect opposite ends of the running strip, a photo-taking device such as a camera was situated above the strip, a photo of the strip was taken by means of the photo-taking device, and opposite ends of the strip were detected in the taken photograph, in a conventional system.

A strip is not always running at a constant height, but is sometimes partially rising or waving. That is, a strip sometimes partially moves vertically while running.

Since a camera taking a photograph of a strip is arranged on the assumption that a strip runs at a constant height, if a strip partially vertically moves, locations of opposite ends of a strip would vary in a field of view of the camera, and resultingly, there would be caused an error in detecting locations of the ends.

In order to solve the above-mentioned problem, there has been suggested an apparatus for detecting an end of a strip, which views a target in two view points different from each other to thereby three-dimensionally detects a location of the target (this is called “stereo-viewing”). The suggested apparatus makes it possible to accurately detect a location of an end or ends of a strip without being influenced by vertical motion of the strip, even if the strip partially vertically moves, because two cameras carry out stereo-viewing.

However, the apparatus is accompanied with a structural problem that two cameras have to be prepared for each of ends.

In order to solve this problem, for instance, Japanese Patent Application Publication No. 2007-170948 has suggested an apparatus for detecting a location of an end of a strip, which is capable of detecting an end of strip with a single camera.

FIG. 16 is a view showing a structure of the apparatus suggested in the above-identified Publication.

The apparatus 1000 illustrated in FIG. 16 detects locations of opposite ends of a strip 2000 running in a direction perpendicular to a plane of FIG. 16, and further, a width W of the strip 2000.

The apparatus 1000 includes a first camera 1100 for taking a photograph of one of ends of the strip 2000, a second camera 1200 for taking a photograph of the other end of the strip 2000, an illuminator 1300 situated below the strip 2000 and irradiating a light onto the strip 2000 in a width-wise direction thereof (a left-right direction in FIG. 16), and a calculation unit 1400 for calculating locations of the opposite ends of the strip 2000 (or a width W of the strip 2000), based on images taken by the first and second cameras 1100 and 1200.

The illuminator 1300 includes a light source 1301 extending in a width-wise direction of the strip 2000, and a half mirror 1302 situated between the light source 1301 and the strip 2000.

The half mirror 1302 has a lower surface 1302A through which a light can pass, and an upper surface 1302B at which a light is reflected.

A part of lights irradiated from the light source 1301 passes through the half mirror 1302 without being interfered with the strip 2000, and are directly received by the first and second cameras 1100 and 1200. The remainder of lights passes through the half mirror 1302, and then, are reflected at a lower surface of the strip 2000, and further, reflected at the upper surface 1302B of the half mirror 1302, and then, received by the first and second cameras 1100 and 1200.

The calculation unit 1400 detects locations of opposite ends of the strip 2000 in dependence on an amount of lights received by the first and second cameras 1100 and 1200.

FIG. 17(A) and FIG. 17(B) are views showing a principle in accordance with which the apparatus 1000 illustrated in FIG. 16 detects locations of the ends. Specifically, FIG. 17(A) illustrates an optically positional relation among the first camera 1100, the strip 2000, the half mirror 1302, and the light source 1301, and FIG. 17(B) illustrates a signal level detected by the first camera 1100.

Points are defined as follows.

Pc: a principal point of a light-receiving lens of the first camera 1100

Po: an intersection of an optical axis of the first camera 1000 with a plane in which the half mirror 1302 is contained

Pe: a lower corner of the strip 2000

Pd: an intersection of an extension of a line connecting the points Pc and Pe to each other with a plane in which the half mirror 1302 is contained

Pee: a point located symmetrical with the point Pe about a plane in which the half mirror 1302 is contained

Pr: an intersection of a line connecting the points Pc and Pee to each other with the half mirror 1302

The first camera 1100 scans an area covering the point Po to the point Pd, resulting in that a signal illustrated in FIG. 17(B) is obtained.

Specifically, as a result that the first camera 1100 scans an area covering the point Po to the point Pd, a light having been irradiated from the light source 1301 and having passed through the half mirror 1302 directly enters the first camera 1100. Thus, there is obtained a signal level “v1”.

Then, as a result that the first camera 1100 scans an area covering the point Pr to the point Pd, there is obtained a signal level (v1+v2), that is, a sum of a signal level “v1” of a light having passed through the half mirror 1302 and having been received by the first camera 1100, and a signal level “v2” of a light having passed through the half mirror 1302, having been reflected at a lower surface of the strip 2000, having been further reflected at the upper surface 1302B of the half mirror 1302, and having been received by the first camera 1100.

When the first camera 1100 scans beyond the point Pd, since a light irradiated from the light source 1301 is shut out by the strip 2000, the first camera 1100 does not receive the light, resulting in that a signal level is “v0”.

Times T0, T1 and T2 corresponding to the points Po, Pr and Pd are detected by comparing each of the signal levels to a predetermined signal level “vt12”.

Both a distance Wa1 between the points Po and Pr and a distance Wa2 between the points Po and Pd can be calculated based on the signal levels obtained by the scanning of the first camera 1100, and further, locations of opposite ends of the strip 2000 can be calculated based on the distances Wa1 and Wa2.

### PRIOR ART REFERENCE

### Patent Document

Patent Document 1: Japanese Patent Application Publication No. 2007-170948

### DISCLOSURE OF THE INVENTION

### Problems to be Solved by the Invention

Though the conventional apparatus 1000 illustrated in FIG. 16, FIG. 17(A) and FIG. 17(B) makes it possible to detect one of opposite ends of the strip 2000 by means of a single camera 1100 or 1200, the apparatus 1000 has to include the half mirror 1302, and unavoidably, have a complicated structure.

In addition, since the conventional apparatus 1000 has to carry out complex calculation, based on the signal levels illustrated in FIG. 17(B), in order to detect locations of an end of the strip 2000. Hence, it is unavoidable that the calculation unit 1400 has to have high performance ability, and carry out calculation in a long time.

In view of the above-mentioned problems in the conventional apparatus 1000, it is an object of the present invention to provide an apparatus for detecting a location of an end of a strip and a method of doing the same, both of which are capable of detecting a location of an end of a strip without having a complicated structure, that is, without including the half mirror 1302, and further, without carrying out complex calculation.

### SOLUTION TO THE PROBLEMS

In order to accomplish the above-mentioned object, the present invention provides an apparatus for detecting an end of a strip in width-wise and height-wise directions, the strip being running in a direction with vertical motion, the apparatus including a first light-source irradiating a light onto the strip, a second light-source situated above the strip and irradiating a linear light onto the strip in an area in which a light is irradiated from the first light-source, a camera taking a photo of an area of the strip including an area in which the linear light irradiated from the second light-source is irradiated, the camera having an incident angle different from an entrance angle of the linear light irradiated from the second light-source, and a calculation unit calculating a location of an end of the strip in width-wise and height-wise directions thereof, based on an image resulted from a light irradiated from the first light-source and an image resulted from a light irradiated from the second light-source and reflected at the strip.

In the apparatus in accordance with the present invention, it is preferable that a difference between the entrance angle and the incident angle is in the range of 5 degrees and 75 degrees both inclusive.

In the apparatus in accordance with the present invention, it is preferable that one of the second-light source and the camera is oriented perpendicularly to a surface of the strip.

In the apparatus in accordance with the present invention, it is preferable that the first light-source is situated below the strip.

In the apparatus in accordance with the present invention, it is preferable that the first light-source irradiates a light in a direction in which the camera takes a photo of the strip.

It is preferable that the apparatus in accordance with the present invention further includes a light-diffuser situated between the strip and the first light-source.

In the apparatus in accordance with the present invention, it is preferable that the first light-source is situated above the strip.

In the apparatus in accordance with the present invention, it is preferable that the second light-source irradiates a light having a brightness greater than the same of a light irradiated from the first light-source.

In the apparatus in accordance with the present invention, it is preferable that the second light-source irradiates a light having a wavelength different from the same of a light irradiated from the first light-source, and the camera is able to take a colored photo.

The present invention further provides an apparatus for detecting an end of a strip in width-wise and height-wise directions, the strip being running in a direction with vertical motion, and irradiating a light itself, the apparatus including a second light-source situated above the strip and irradiating a linear light onto the strip, a camera taking a photo of an area of the strip including an area in which the linear light irradiated from the second light-source is irradiated, the camera having an incident angle different from an entrance angle of the linear light irradiated from the second light-source, and a calculation unit calculating a location of an end of the strip in width-wise and height-wise directions thereof, based on an image resulted from a light irradiated from the strip and an image resulted from a light irradiated from the second light-source and reflected at the strip.

In the apparatus in accordance with the present invention, it is preferable that the second light-source irradiates a light having a brightness greater than the same of a light irradiated from the strip.

In the apparatus in accordance with the present invention, it is preferable that the second light-source irradiates a light having a wavelength different from the same of a light irradiated from the strip, and

the camera is able to take a colored photo.

In the apparatus in accordance with the present invention, it is preferable that the camera is oriented perpendicularly to a surface of the strip.

In the apparatus in accordance with the present invention, it is preferable that the calculation unit calculates a location of an end of the strip in a width-wise direction thereof, based on an intersection of a boundary line between a bright area and a dark area in an image resulted from the first light-source or the strip, with a linear image resulted from the second light-source.

In the apparatus in accordance with the present invention, it is preferable that the calculation unit calculates a height of an end of the strip in accordance with a distance between a linear image resulted from the second light-source when the strip is running at a reference height and an actually obtained linear image.

In the apparatus in accordance with the present invention, it is preferable that the camera comprises a two-dimensional camera.

The present invention further provides a method of detecting an end of a strip in width-wise and height-wise directions, the strip being running in a direction with vertical motion, the method including a first step of irradiating a light onto the strip, a second step of irradiating a linear light onto the strip in an area in which a light irradiated in the first step is irradiated onto the strip, a third step of taking a photo of an area of the strip including an area in which the linear light irradiated in the second step is irradiated, with an incident angle different from an entrance angle of the linear light irradiated in the second step, and a fourth step of calculating a location of an end of the strip in width-wise and height-wise directions thereof, based on an image resulted from the first step and an image resulted from the second step.

In the method in accordance with the present invention, it is preferable that a difference between the entrance angle and the incident angle is in the range of 5 degrees and 75 degrees both inclusive.

In the method in accordance with the present invention, it is preferable that one of irradiation of the linear light in the second step and taking a photo in the third step is carried out perpendicularly to a surface of the strip.

In the method in accordance with the present invention, it is preferable that a light is irradiated onto a lower surface of the strip in the first step.

It is preferable that the method in accordance with the present invention further includes a step of diffusing a light before it reaches the strip.

In the method in accordance with the present invention, it is preferable that a light is irradiated onto an upper surface of the strip in the first step.

It is preferable that the method in accordance with the present invention further includes a step of setting a light irradiated in the second step to have a brightness greater than the same of a light irradiated in the first step.

It is preferable that the method in accordance with the present invention further includes a step of setting a light irradiated in the second step to have a wavelength different from the same of a light irradiated in the first step.

In the method in accordance with the present invention, it is preferable that an end of the strip in a width-wise direction is calculated in the fourth step, based on an intersection of a boundary between a bright area and a dark area found in an image resulted from the first step, with a linear image resulted from the second step.

In the method in accordance with the present invention, it is preferable that an end of the strip in a height-wise direction is calculated in the fourth step, based on a distance between a linear image resulted from the second step when the strip is running at a reference height, and an actually obtained linear image.

The present invention further provides a method of detecting an end of a strip in width-wise and height-wise directions, the strip spontaneously irradiating a light and being running in a direction with vertical motion, the method including a first step of irradiating a linear light onto an upper surface of the strip, a second step of taking a photo of an area of the strip including an area in which the linear light irradiated in the first step is irradiated, with an incident angle different from an entrance angle of the linear light irradiated in the second step, and a third step of calculating a location of an end of the strip in width-wise and height-wise directions thereof, based on an image resulted from the first step and an image resulted from the light irradiated from the strip.

In the method in accordance with the present invention, it is preferable that a difference between the entrance angle and the incident angle is in the range of 5 degrees and 75 degrees both inclusive.

In the method in accordance with the present invention, it is preferable that one of irradiation of the linear light in the first step and taking a photo in the second step is carried out perpendicularly to a surface of the strip.

It is preferable that the method in accordance with the present invention further includes a step of setting a light irradiated in the first step to have a brightness greater than the same of a light irradiated from the strip.

It is preferable that the method in accordance with the present invention further includes a step of setting a light irradiated in the first step to have a wavelength different from the same of a light irradiated from the strip.

In the method in accordance with the present invention, it is preferable that an end of the strip in a width-wise direction is calculated in the third step, based on an intersection of a boundary between a bright area and a dark area found in an image resulted from a light irradiated from the strip, with a linear image resulted from the first step.

In the method in accordance with the present invention, it is preferable that an end of the strip in a height-wise direction is calculated in the third step, based on a distance between a linear image resulted from the first step when the strip is running at a reference height, and an actually obtained linear image.

### Advantages Provided by the Invention

The apparatus for detecting an end of a strip in width-wise and height-wise directions and the method of doing the same, both in accordance with the present invention, make it possible to accurately detect locations of opposite ends of a running strip in a width-wise directions without including an additional element such as the half mirror 1302 unlike the conventional apparatus 1000 illustrated in FIG. 16, and further without being influenced by partial upward and downward motion of a strip.

Furthermore, the apparatus for detecting an end of a strip in width-wise and height-wise directions and the method of doing the same, both in accordance with the present invention, make it possible to detect a height of opposite ends of a strip (a height relative to a reference height), if a running strip partially rises.

### BRIEF DESCRIPTION OF THE DRAWINGS

FIG. 1 illustrates a structure of the apparatus for detecting an end of a strip in width-wise and height-wise directions, in accordance with the first embodiment of the present invention.

FIG. 2 is a perspective view showing a three-dimensional positional relation among the first light-source, the second light-source and the camera in the apparatus in accordance with the first embodiment of the present invention.

FIG. 3 illustrates an example of an image of the strip taken by the camera in the apparatus in accordance with the first embodiment of the present invention.

FIG. 4 is a block diagram of an example of a structure of the calculation unit in the apparatus in accordance with the first embodiment of the present invention.

FIG. 5 illustrates the strip partially rising while running.

FIG. 6 illustrates an example of an image taken by the camera when the strip runs at a height H₁.

FIG. 7 illustrates the apparatus in which the camera is situated to have an optical axis perpendicular to a surface of the strip, and the second light-source is situated to have an optical axis inclining relative to a surface of the strip.

FIG. 8(A) illustrates an image obtained when the camera is situated inclined relative to a surface of the strip, and FIG. 8(B) illustrates an image obtained when the camera is situated perpendicular to a surface of the strip.

FIG. 9 illustrates a structure of the apparatus for detecting an end of a strip in width-wise and height-wise directions, in accordance with a variant of the first embodiment of the present invention.

FIG. 10 illustrates a structure of the apparatus for detecting an end of a strip in width-wise and height-wise directions, in accordance with a variant of the first embodiment of the present invention.

FIG. 11 illustrates a structure of the apparatus for detecting an end of a strip in width-wise and height-wise directions, in accordance with a first variant of the first embodiment of the present invention.

FIG. 12 illustrates a structure of the apparatus for detecting an end of a strip in width-wise and height-wise directions, in accordance with a second variant of the first embodiment of the present invention.

FIG. 13 illustrates a structure of the apparatus for detecting an end of a strip in width-wise and height-wise directions, in accordance with the second embodiment of the present invention.

FIG. 14 illustrates an example of an image of the strip taken by the camera in the apparatus in accordance with the second embodiment of the present invention.

FIG. 15 illustrates a structure of the apparatus for detecting an end of a strip in width-wise and height-wise directions, in accordance with the third embodiment of the present invention.

FIG. 16 illustrates a structure of the conventional apparatus for detecting a location of an end of a strip.

FIG. 17(A) illustrates an optically positional relation among the first camera, the strip, the half mirror, and the light source in the conventional apparatus, and FIG. 17(B) illustrates a signal level detected by the first camera.

### BEST EMBODIMENT FOR REDUCING THE INVENTION TO PRACTICE

### First Embodiment

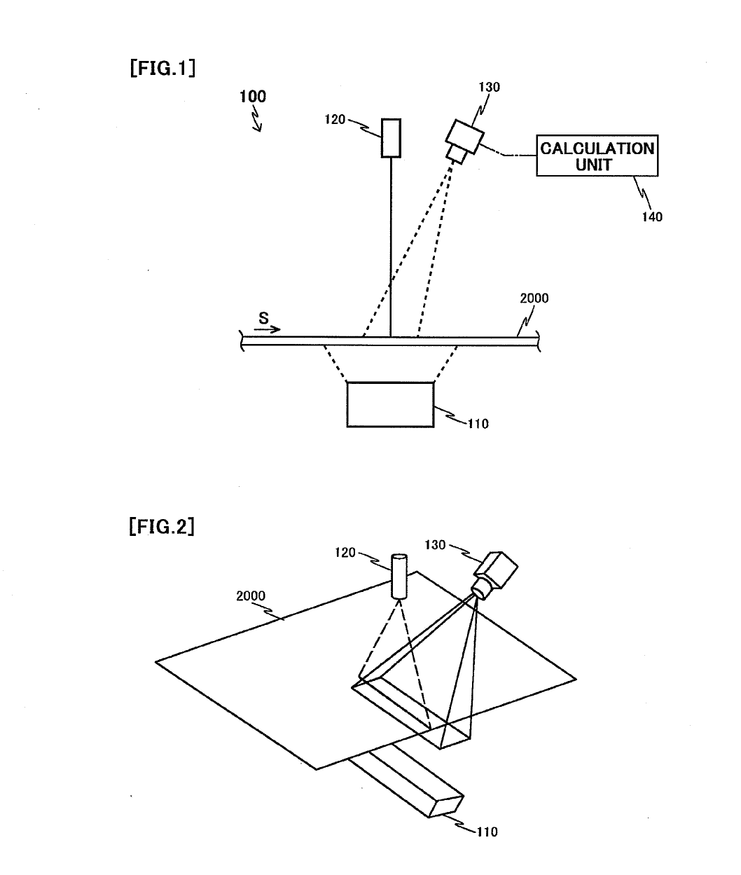

FIG. 1 illustrates a structure of the apparatus 100 for detecting an end of a strip in width-wise and height-wise directions, in accordance with the first embodiment of the present invention.

The apparatus 100 in accordance with the first embodiment detects opposite ends of a strip 2000 in a width-wise direction (opposite ends in a direction perpendicular to a plane defined by FIG. 1), running in a direction S towards right in FIG. 1, and further, a height (a location in a height-wise direction) of the ends.

The strip 2000 is not always running at a constant height, but is sometimes partially rising or waving. That is, the strip 2000 sometimes partially moves vertically while running.

The apparatus 100 in accordance with the first embodiment includes a first light-source 110 irradiating a light onto a lower surface of the strip 2000, a second light-source 120 irradiating a linear light onto an upper surface of the strip 2000, a camera 130, and a calculation unit 140 calculating a location of an end or locations of opposite ends of the strip 2000.

The first light-source 110 is situated below the strip 2000, and has a length extending in a width-wise direction of the strip 2000 (a direction perpendicular to a sheet of FIG. 1). The first light-source 110 has a length longer than a full width of the strip 2000, and irradiates a light onto a lower surface of the strip 2000 in a plane over a full width of the strip 2000.

The second light-source 120 is situated above the strip 2000 such that an optical axis thereof is perpendicular to the strip 2000, and irradiates a light (a line beam) perpendicularly to a surface of the strip 2000. As illustrated in FIG. 2, the second light-source 120 irradiates a line beam onto a surface of the strip 2000.

The second light-source 120 may be comprised of a line laser, for instance.

The second light-source 120 irradiates a line beam onto a surface of the strip 2000 in an area in which the first light-source 110 irradiates a light.

The camera 130 may be comprised of a two-dimensional camera such as a CCD camera, for instance.

The camera 130 is directed at a predetermined inclination angle perpendicularly to a surface of the strip 2000, and keeps monitoring in a field of view thereof an area in which a linear beam is irradiated onto the strip 2000 from the second light-source 120. Specifically, the camera 130 takes a photo of an area in which the linear beam is irradiated from the second light-source 120, and further, an area around the above-identified area.

The calculation unit 140 calculates locations of opposite ends of the strip 2000 in width-wise and height-wise directions thereof, based on an image resulted from a light irradiated from the first light-source 110 and an image resulted from a light irradiated from the second light-source 120 and reflected at the strip 2000.

FIG. 4 is a block diagram of an example of the calculation unit 140.

The calculation unit 140 is comprised of a central processing unit (CPU) 141, a first memory 142, a second memory 143, an input interface 144 through which commands and/or data are input into the central processing unit 141, an output interface 145 through which results of analysis having been executed by the central processing 141 unit is output, and buses 514766 through which the central processing unit 141 are electrically connected to the first memory 142, the second memory 143, the input interface 144, and the output interface 145.

Each of the first and second memories 142 and 143 is comprised of a semiconductor memory such as a read only memory (ROM), a random access memory (RAM) or an IC memory card, or a storage device such as a flexible disc, a hard disc or an optic magnetic disc. In the first embodiment, the first memory 142 is comprised of ROM, and the second memory 143 is comprised of RAM.

The first memory 142 stores therein both various control programs to be executed by the central processing unit 141 and fixed data. The second memory 143 stores therein various data and parameters, and presents a working area to the central processing unit 141. That is, the second memory 143 stores data which is temporarily necessary for the central processing unit 141 to execute programs.

The central processing unit 141 reads the program out of the first memory 142, and executes the program. Thus, the central processing unit 141 operates in accordance with the program stored in the first memory 142.

FIG. 2 is a perspective view showing a three-dimensional positional relation among the first light-source 110, the second light-source 120 and the camera 130.

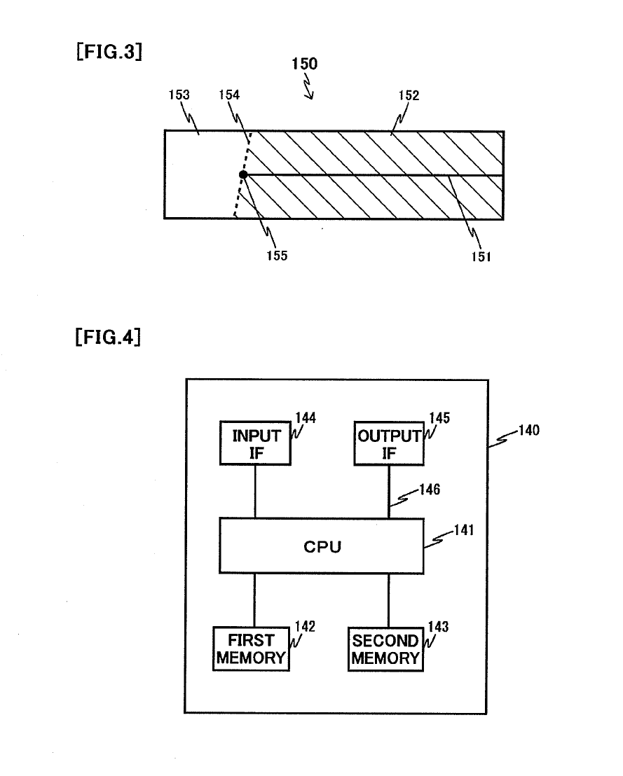

FIG. 3 illustrates an example of an image of the strip 2000 taken by the camera 130. The calculation unit 140 calculates an end of the strip 2000, based on the image illustrated in FIG. 3.

Hereinbelow is explained the operation of the apparatus 100 in accordance with the first embodiment, with reference to FIGS. 1 to 3.

As illustrated in FIGS. 1 and 2, the first light-source 110 irradiates a light onto a lower surface of the strip 2000 running in the direction S, and the second light-source 120 irradiates a linear beam perpendicularly onto an upper surface of the strip 2000 within an area in which the first light-source 110 irradiates a light.

The camera 130 takes a photo of an area in which an area to which the linear beam is irradiated from the second light-source 120 is centrally located, at a predetermined inclination angle relative to a vertical direction. An example of the thus taken images 150 is illustrated in FIG. 3.

As illustrated in FIG. 3, a linear image 151 resulted from the linear beam irradiated from the second light-source 120 extends almost centrally of the image 150.

The image 150 is divided to two areas, that is, a dark area 152 (a hatched area) and a bright area 153 (a non-hatched area).

The dark area 152 indicates an area of a lower surface of the strip 2000 onto which a light is irradiated from the first light-source 110, and the bright area 153 indicates an area in which a light irradiated from the first light source 110 directly enters the camera 130 (that is, without being interfered with the strip 2000).

Since the linear beam is irradiated onto a surface of the strip 2000 from the second light-source 120, the linear image 151 is always situated within the dark area 152.

The image 150 taken by the camera 130 is transmitted to the calculation unit 140.

The calculation unit 140 detects a brightness (lightness) of the image 150 received from the camera 130, and identifies the dark area 152 and the bright area 153, based on a difference in brightness, and then, defines a boundary 154 (shown with a broken line) between the dark area 152 and the bright area 153.

In addition, the calculation unit 140 identifies the linear image 151 (exactly, a center line of the linear image 151) hidden in the dark area 152, based on a brightness difference.

Then, the calculation unit 140 identifies an intersection 155 of the linear image 151 with the boundary 154.

As is obvious in view of FIG. 3, the dark area 152 indicates existence of the strip 2000, and the linear image 151 indicates the linear beam irradiated from the second light-source 120. Accordingly, the intersection 155 at which the boundary 154 indicative of a boundary between the dark area 152 and the bright area 153 intersects with the linear image 151 indicates a location of an end of the strip 2000.

The calculation unit 140 converts the thus obtained coordinate of the intersection 155 situated within a field of view of the camera 130 into an actual spatial coordinate, based on both a positional relation among the camera 130, the first light-source 110 and the second light-source 120, and predetermined calibration data, to thereby identify a location of an end of the strip 2000.

Though FIG. 3 illustrates only a location of one of ends of the strip 2000, the other end can be identified in the same way.

The apparatus 100 in accordance with the first embodiment can identify a location of opposite ends of the strip 2000 in a width-wise direction thereof in the above-mentioned manner.

When the boundary 154 is identified, it is possible to enhance an efficiency and reliability of image processing by carrying out image-processing only around a distal end of the linear image 151.

As mentioned earlier, the strip 2000 partially vertically moves while running.

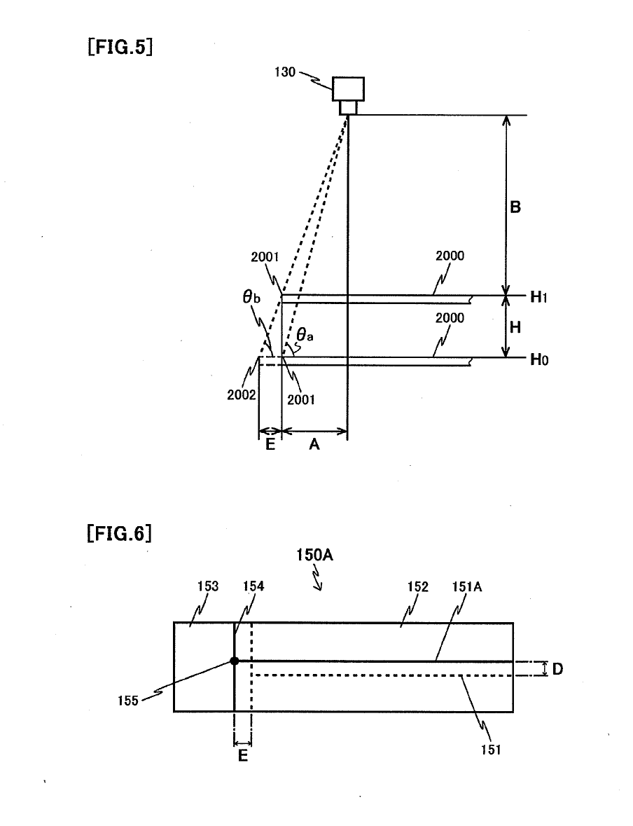

FIG. 5 illustrates the strip 2000 partially rising while running. In FIG. 5, the strip 2000 is illustrated in a direction perpendicular to the direction S (a direction perpendicular to a sheet of FIG. 5) in which the strip 2000 runs.

Assuming that the strip 2000 usually runs at a reference height H₀, the strip 2000 sometimes partially runs at a height H1 higher than the reference height Ho by H. In such a case, since the camera 130 is arranged on the assumption that the strip 2000 runs at the reference height H₀, if the strip 2000 actually runs at the height H₁, a positional relation between the camera 130 and the strip 2000 varies, and hence, a relative position of the strip 2000 in a field of view of the camera 130 varies.

When the strip 2000 runs at the reference height H₀, the camera 130 views an edge 2001 of the strip 2000 at a visibility angle θa.

On the other hand, when the strip 2000 runs at the height H₁, the camera 130 views the edge 2001 of the strip 2000 at a visibility angle θb. In such a case, since the camera 130 assumes that the strip 2000 runs at the reference height H₀, the camera 130 views an intersection 2002 at which an extension of a line of the visibility angle θb passing through the edge 2001 of the strip 2000 running at the height H₁ intersects with a surface of the strip 2000 situated at the reference height H₀, as the edge 2001 of the strip 2000.

Thus, the camera 130 misunderstands a position 2002 located remote from the edge 2001 by a horizontal distance E, as a position of the edge 2001 of the strip 2000.

As illustrated in FIG. 5, assuming a horizontal distance between the optical axis of the camera 130 and the edge 2001 of the strip 2000 is indicated as “A”, and a difference in height between a surface of the strip 2000 running at the height H₁ and the camera 130 is indicated as “B”, there is obtained a following expression.

H/E=(H+B)/(E+A)

Since both “H” and “E” are microlength, there is obtained an approximate expression of the above-mentioned expression.

H/E=B/A

That is, the following expression is obtained.

E=HA/B

For instance, if A=200 mm, B=1000 mm, and H=5 mm, E is equal to 1 mm. (E=1 mm).

FIG. 6 illustrates an example of an image 150A taken by the camera 130 when the strip 2000 runs at the height H₁.

Similarly to the image 150 illustrated in FIG. 3, a linear image 151A resulted from the linear beam irradiated from the second light-source 120 is found also in the image 150A illustrated in FIG. 6. However, a relative position of the linear image 151A in the image 150A is different from a relative position of the linear image 151 in the image 150.

Specifically, as is obvious in view of the comparison of FIGS. 3 and 6 to each other, a relative position of the linear image 151A in the image 150A is upwardly deviated by a distance D from a relative position of the linear image 151 in the image 150.

Furthermore, since the strip 2000 vertically approaches the camera 130 by the height H because the strip 2000 runs at the height H₁, an end of the linear image 151A outwardly moves by a distance E (see FIG. 5) relative to an end of the linear image 151.

The distance D is independent on the height H. Accordingly, the calculation unit 1400 is able to calculate the height H by measuring the distance D, if a correspondence between the height H and the distance D is obtained in advance (the correspondence varies in accordance with a positional relation between the strip 2000 and the camera 130).

After the height H was calculated, the calculation unit 140 compensates for a position of an end of the strip 2000, based on a relative positional relation between the strip 2000 running at the reference height H₀ and the camera 130, to thereby calculate an accurate position of an end of the strip 2000.

It is preferable that the reference height H₀ is set equal to a lowest height among heights which the strip 2000 can take, if the strip 2000 is rigid.

The strip 2000 is usually transferred on rollers, if the strip 2000 is rigid. Thus, setting the reference height H₀ to be equal to a height of the strip 2000 situated on rollers, the strip 2000 cannot be situated below the reference height H₀, and hence, what is to be considered is only a height equal to or higher than the reference height H₀.

In contrast, if the strip 2000 is composed of a easily deformable material such as a film and a paper, the strip 2000 keeps tensioned and is transferred by being wound around a plurality of rollers. In such a case, a location at which the strip 2000 runs among rollers varies due to various factors such as deflection caused by a weight of itself, fluctuation of a tension force, a flatness of the strip 2000, and oscillation of a transfer unit. Accordingly, if the strip 2000 is composed of a deformable material, the reference height H₀ is set equal to an average of heights taken by the running strip 2000. Consequently, a height of the strip 2000 may vary to both a height higher than the reference height H₀ and a height lower than the reference height H₀.

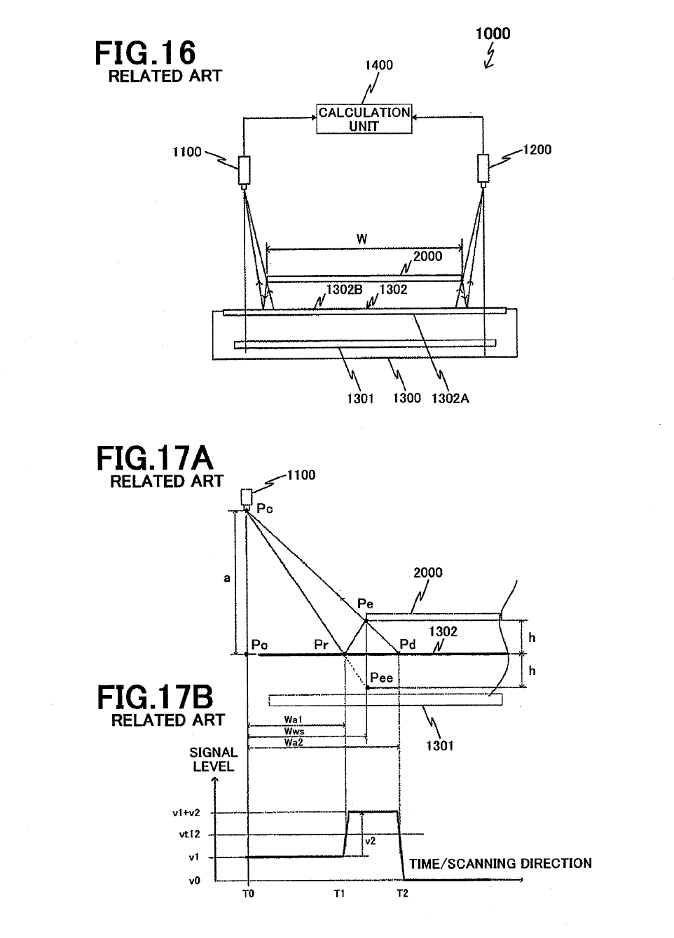

As explained above, the apparatus 100 for detecting an end of a strip, in accordance with the first embodiment, makes it possible to accurately detect locations of opposite ends of the running strip 2000 in a width-wise direction without including an additional element such as the half mirror 1302 unlike the conventional apparatus 1000 illustrated in FIG. 16, and further without being influenced by partial upward and downward motion of a strip 2000. Furthermore, it is possible to detect a height H₁ of opposite ends of the strip 2000 (a height relative to the reference height H₀), if the running strip 2000 partially rises.

The apparatus 100 in accordance with the first embodiment is not to be limited to the above-mentioned structure, but may be designed to have various variations.

For instance, in the apparatus 100 in accordance with the first embodiment, the second light-source 120 is designed to have an optical axis perpendicular to a surface of the strip 2000, and the camera 130 is designed to have an optical axis inclined to a surface of the strip 2000. In contrast, the camera 130 may be designed to have an optical axis perpendicular to a surface of the strip 2000, and the second light-source 120 may be designed to have an optical axis inclined to a surface of the strip 2000.

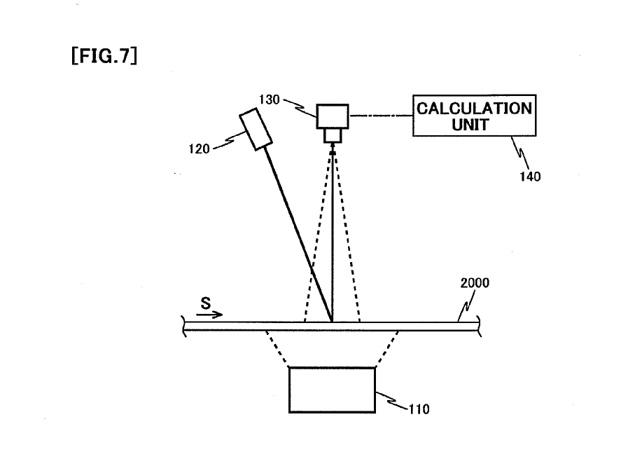

FIG. 7 illustrates the apparatus 100 in which the camera 130 is situated to have an optical axis perpendicular to a surface of the strip 2000, and the second light-source 120 is situated to have an optical axis inclining relative to a surface of the strip 2000.

Taking a photo of an end of the strip 2000 by means of the camera 130 situated perpendicular to a surface of the strip 2000, it is possible to catch the boundary 154 within the image 150 at a constant angle regardless of a location thereof in a width-wise direction (a left-right direction in FIG. 3) of the image 150.

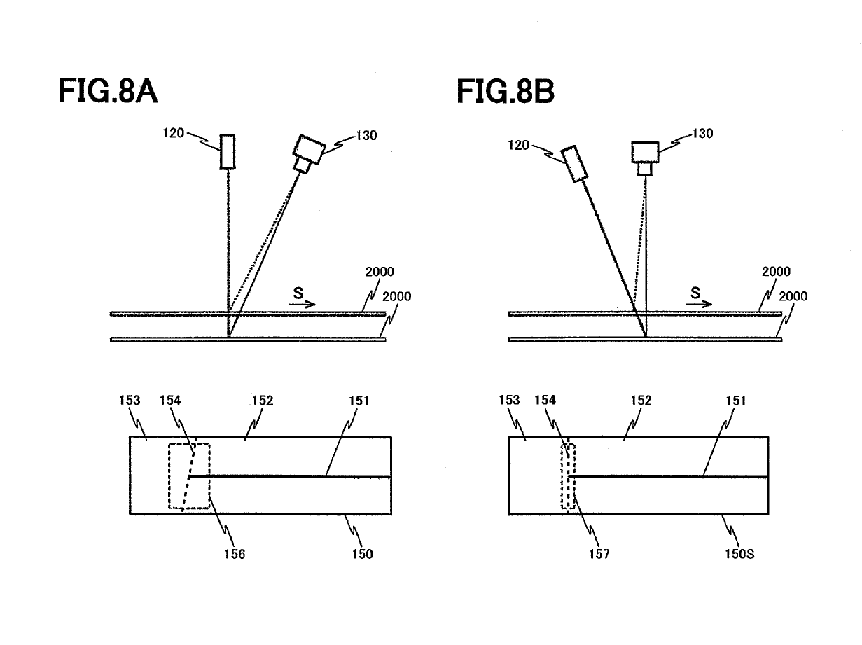

FIG. 8(A) illustrates an image 150 (the image 150 illustrated in FIG. 3) obtained when the camera 130 is situated inclined relative to a surface of the strip 2000, and FIG. 8(B) illustrates an image 150S obtained when the camera 130 is situated perpendicular to a surface of the strip 2000.

As illustrated in FIG. 8(A), since it is not possible to catch the boundary 154 at a constant angle in the image 150, the boundary 154 inclines relative to a vertical direction of the image 150.

In contrast, as illustrated in FIG. 8(B), since it is possible to catch the boundary 154 at a constant angle in the image 150S, the boundary 154 is in parallel with a vertical direction of the image 150.

Thus, an area for entirely catching the boundary 154 (an area for processing an image) is a rectangle 156 in the image 150 illustrated in FIG. 8(A), and an area for entirely catching the boundary 154 (an area for processing an image) is a rectangle 157 in the image 150S illustrated in FIG. 8(B). Since the boundary 154 in the image 150S is in parallel with a vertical direction, the rectangle 157 is obviously smaller than the rectangle 156.

Specifically, it is possible to narrow an image-processing area for catching the boundary 154 therein by designing the camera 130 to have an optical axis perpendicular to a surface of the strip 2000, in comparison with a case wherein the camera 130 is designed to have an optical axis inclining to a surface of the strip 2000, and resultingly, it is possible to shorten a period of time necessary for carrying out image-processing in the calculation unit 140. Furthermore, since the boundary 154 can be recognized in a narrower area, it is possible to reduce an efficiency of misrecognition or an error caused by defects at a surface of the strip 2000 and/or irregularity in lighting.

As an alternative, it is not always necessary to design the second light-source 120 or the camera 130 to have an optical axis perpendicular to a surface of the strip 2000. The second light-source 120 and the camera 130 may be situated at any location, if they do not have a common optical axis.

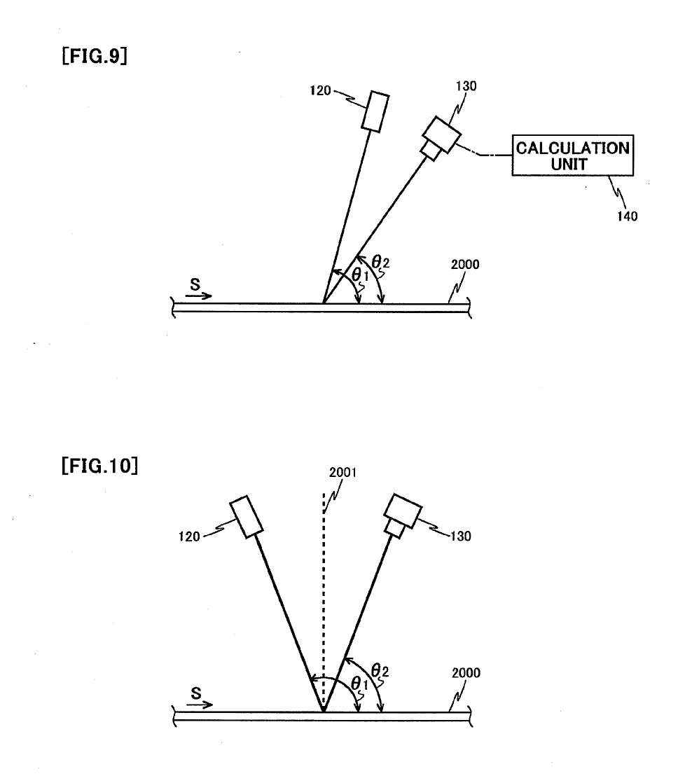

FIG. 9 illustrates a structure of the apparatus 100 in which neither the second light-source 120 nor the camera 130 are designed to have an optical axis perpendicular to a surface of the strip 2000.

As illustrated in FIG. 9, by designing an entrance angle θ₁ (an angle formed by the linear beam with a horizontal plane, 0≦θ₁≦180) at which the second light-source 120 irradiates the linear beam to be different from an incident angle θ₂ (an angle formed by a reflected light entering the camera 130 with a horizontal plane, 0≦θ₂≦180) of the camera 130, the second light-source 120 and the camera 130 can be arranged at any direction relative to a surface of the strip 2000. The greater a difference between the entrance angle θ₁ and the incident angle θ₂ (θ₁-θ₂) is, the greater a resolution (an accuracy at which the difference H in height (see FIG. 5) is detected) in a height-wise direction is.

Thus, it is preferable that a difference between the entrance angle θ₁ at which the linear beam is irradiated from the second light-source 120 and the incident angle θ₂ at which a reflected light is introduced into the camera 130 is in the range of 5 degrees to 75 degrees both inclusive.

Hereinbelow are explained variants of the apparatus 100 in accordance with the first embodiment.

### First Variant of the First Embodiment

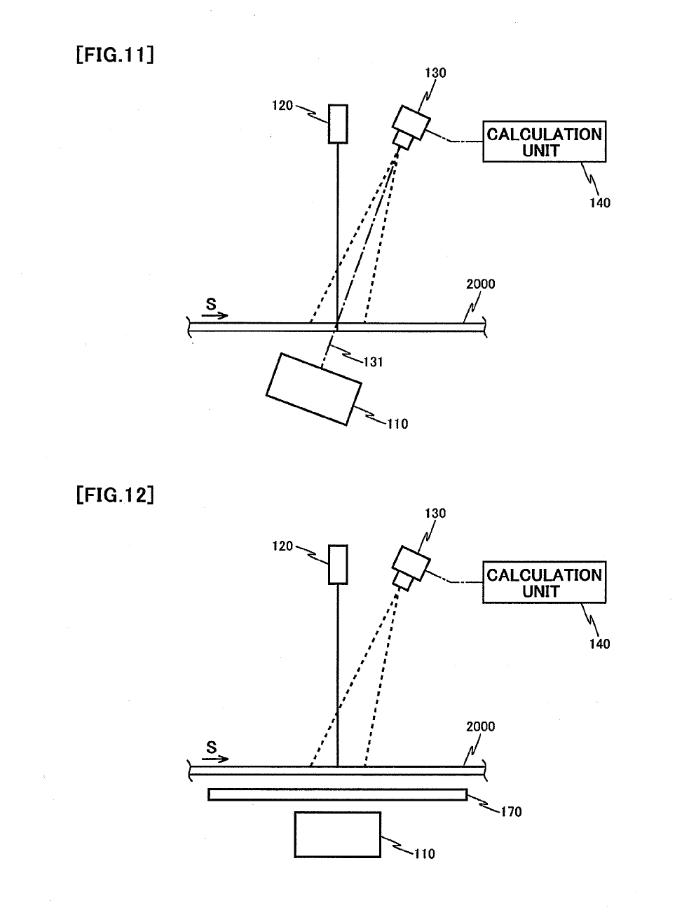

FIG. 11 illustrates a structure of the apparatus 100 in accordance with a first variant of the first embodiment of the present invention.

In the first variant, as illustrated in FIG. 11, the first light-source 110 is inclined so as to irradiate a light in parallel with an optical axis 131 of the camera 130.

By inclining the first light-source 110, it is possible to effectively illuminate a lower surface of the strip 2000.

### Second Variant of the First Embodiment

FIG. 12 illustrates a structure of the apparatus 100 in accordance with a second variant of the first embodiment of the present invention.

In the second variant, as illustrated in FIG. 12, a light-diffuser 170 is situated between the strip 2000 and the first light-source 110.

By disposing the light-diffuser 170 between the strip 2000 and the first light-source 110, it is possible to reduce a size of a surface at which the first light-source 110 irradiates a light.

### Second Embodiment

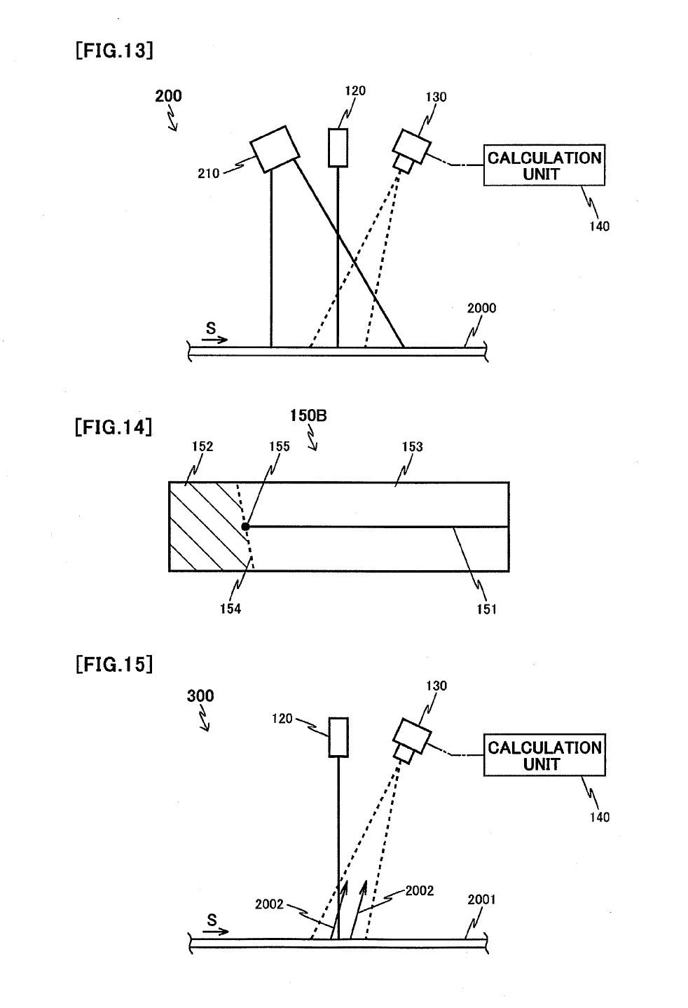

FIG. 13 illustrates a structure of the apparatus 200 for detecting an end of a strip, in accordance with the second embodiment of the present invention.

The apparatus 200 in accordance with the second embodiment is designed to include a first light-source 210 in place of the first light-source 110 in comparison with the apparatus 100 in accordance with the first embodiment. The apparatus 200 in accordance with the second embodiment has the same structure as that of the apparatus 100 in accordance with the first embodiment except including the first light-source 210 in place of the first light-source 110. Accordingly, parts or elements that correspond to those of the first embodiment have been provided with the same reference numerals.

The first light-source 210 is situated above the strip 2000, and irradiates a light onto a surface of the strip 2000 around the linear beam irradiated from the second light-source 120.

Furthermore, the second light-source 120 is designed to irradiate a light having a brightness greater than the same of a light irradiated from the first light-source 210.

Hereinbelow is explained the operation of the apparatus 200 in accordance with the second embodiment.

As illustrated in FIG. 13, the first light-source 210 irradiates a light onto a surface of the strip 2000 running in a direction S, and the second light-source 120 perpendicularly irradiates a linear beam onto an upper surface of the strip 2000 in an area in which the first light-source 210 irradiates a light.

The camera 130 takes a photo of an area in which the second light-source 120 irradiates the linear beam, at a predetermined angle relative to a vertical direction. An example of the thus taken image 150B is shown in FIG. 14.

As illustrated in FIG. 14, a linear image 151 resulted from the linear beam irradiated from the second light-source 120 extends almost at a center of the image 150B.

The image 150B is divided to two areas, that is, a dark area 152 (a hatched area) and a bright area 153 (a non-hatched area).

The dark area 152 indicates an area at which lights irradiated from the first light-source 210 and the second light-source 120 are not reflected, that is, an area in which lights irradiated from the first light-source 210 and the second light-source 120 are not reflected at the strip 2000, and do not reach the camera 130. The bright area 153 indicates an area in which lights irradiated from the first light-source 210 and the second light-source 120 are reflected, and reach the camera 130.

Since the linear beam is irradiated onto a surface of the strip 2000 from the second light-source 120, the linear image 151 is always situated within the bright area 153.

Since the second light-source 120 is designed to irradiate a light having a brightness greater than the same of a light irradiated from the first light-source 210, it is possible to recognize the linear image 151, even if the linear image 151 is situated in the bright area 153.

The image 150B taken by the camera 130 is transmitted to the calculation unit 140.

The calculation unit 140 detects a brightness of the image 150B received from the camera 130, identifies the dark area 152 and the bright area 153 in the image 150B, and then, defines a boundary 154 (shown with a broken line) between the dark area 152 and the bright area 153.

In addition, the calculation unit 140 identifies the linear image 151 situated in the bright area 153.

Then, the calculation unit 140 identifies an intersection 155 of the linear image 151 with the boundary 154.

As is obvious in view of FIG. 14, the bright area 153 indicates existence of the strip 2000 therein, and the linear image 151 indicates the linear beam irradiated from the second light-source 120. Accordingly, the intersection 155 at which the boundary 154 indicative of a boundary between the dark area 152 and the bright area 153 intersects with the linear image 151 indicates a location of an end of the strip 2000.

The calculation unit 140 converts the thus obtained coordinate of the intersection 155 situated within a field of view of the camera 130 into an actual spatial coordinate, based on both a positional relation among the camera 130, the first light-source 210 and the second light-source 120, and predetermined calibration data, to thereby identify a location of an end of the strip 2000.

Though FIG. 14 illustrates only a location of one of ends of the strip 2000, the other end can be identified in the same way.

A height of an end of the strip 2000 can be identified in the same way as the first embodiment.

As explained above, the apparatus 200 in accordance with the second embodiment makes it possible to accurately detect locations of opposite ends of the running strip 2000 in a width-wise direction, and further a height H₁ of opposite ends of the strip 2000 (a height relative to the reference height HO.

The apparatus 200 in accordance with the second embodiment is not to be limited to the above-mentioned structure, but may be designed to have various variations.

In the apparatus 200 in accordance with the second embodiment, the first light-source 110 is designed to irradiate a light having a wavelength equal to the same of a light irradiated from the second light-source 120. Alternately, those wavelengths may be different from each other, in which case, it is possible to identify the linear image 151 and the boundary 154 by virtue of not a brightness, but a color, in the processing of the image 150B to be carried out by the calculation unit 140.

For instance, it is assumed that the first light-source 110 irradiates a blue light, and the second light-source 120 irradiates a red light. Since an image resulted from the blue light irradiated from the first light-source 110 and an image resulted from the red light irradiated from the second light-source 120 can be readily separated from each other by means of a suitable filter during image-processing carried out by the calculation unit 140, it is possible to readily and accurately identify the linear image 151 and the boundary 154 in comparison with a case where the linear image 151 and the boundary 154 are identified with brightnesses thereof.

For carrying out image-processing with a color, it is necessary for the camera 130 to be able to take a colored photo.

### Third Embodiment

FIG. 15 illustrates a structure of the apparatus 300 for detecting an end of a strip, in accordance with the third embodiment of the present invention.

The apparatus 300 in accordance with the third embodiment is structurally different from the apparatuses 100 and 200 in accordance with the first and second embodiments in that whereas the apparatuses 100 and 200 are used for the strip 2000 which does not irradiate a light itself, the apparatus 300 is used for a strip 2001 which irradiate a light itself.

Accordingly, the apparatus 300 in accordance with the third embodiment is structurally different from the apparatus 100 in accordance with the first embodiment only in not including the first light-source 110.

In the apparatus 300 in accordance with the third embodiment, a light 2002 irradiated from the strip 2001 is used instead of a light irradiated from the first light-source 110. Thus, the apparatus 300 in accordance with the third embodiment can provide the same advantages as those provided by the apparatus 100 in accordance with the first embodiment.

### INDUSTRIAL APPLICABILITY

The apparatus and the method both in accordance with the present invention make it possible to accurately detect an end of a running strip. Thus, the present invention makes it possible to detect locations of opposite ends of a running strip to thereby control not only locations of opposite ends of a strip, but also a location of a center of a strip in a line for fabricating a strip (for instance, a steel, a metal foil, a film, and a paper).

Furthermore, it is possible to calculate a width of a strip by detecting locations of opposite ends of a strip, in which case, it is possible to continuously monitor whether a running strip has a constant width.

### INDICATION BY REFERENCE NUMERALS

100 Apparatus for detecting an end of a strip, in accordance with the first embodiment of the present invention
110 First light-source
120 Second light-source
130 Camera
140 Calculation unit
141 Central processing unit
142 First memory
143 Second memory
144 Input interface
145 Output interface
150 Image
150A Image
150B Image
151 Linear image
151A Linear image
152 Dark area
153 Bright area
154 Boundary
155 Intersection
170 Light-diffuser
200 Apparatus for detecting an end of a strip, in accordance with the second embodiment of the present invention
210 First light-source
300 Apparatus for detecting an end of a strip, in accordance with the third embodiment of the present invention

1. An apparatus for detecting an end of a strip in width-wise and height-wise directions, said strip being running in a direction with vertical motion, said apparatus comprising:
a first light-source irradiating a light onto said strip;
a second light-source situated above said strip and irradiating a linear light onto said strip in an area in which a light is irradiated from said first light-source;
a camera taking a photo of an area of said strip including an area in which said linear light irradiated from said second light-source is irradiated, said camera having an incident angle different from an entrance angle of said linear light irradiated from said second light-source; and
a calculation unit calculating a location of an end of said strip in width-wise and height-wise directions thereof, based on an image resulted from a light irradiated from said first light-source and an image resulted from a light irradiated from said second light-source and reflected at said strip.

2. The apparatus as set forth in claim 1, wherein a difference between said entrance angle and said incident angle is in the range of 5 degrees and 75 degrees both inclusive.

3. The apparatus as set forth in claim 1, wherein one of said second-light source and said camera is oriented perpendicularly to a surface of said strip.

4. The apparatus as set forth in claim 1, wherein said first light-source is situated below said strip.

5. The apparatus as set forth in claim 4, wherein said first light-source irradiates a light in a direction in which said camera takes a photo of said strip.

6. The apparatus as set forth in claim 4, further comprising a light-diffuser situated between said strip and said first light-source.

7. The apparatus as set forth in claim 1, wherein said first light-source is situated above said strip.

8. The apparatus as set forth in claim 7, wherein said second light-source irradiates a light having a brightness greater than the same of a light irradiated from said first light-source.

9. The apparatus as set forth in claim 1, wherein said second light-source irradiates a light having a wavelength different from the same of a light irradiated from said first light-source, and
said camera is able to take a colored photo.

10. An apparatus for detecting an end of a strip in width-wise and height-wise directions, said strip being running in a direction with vertical motion, and irradiating a light itself, said apparatus comprising:
a second light-source situated above said strip and irradiating a linear light onto said strip;
a camera taking a photo of an area of said strip including an area in which said linear light irradiated from said second light-source is irradiated, said camera having an incident angle different from an entrance angle of said linear light irradiated from said second light-source; and
a calculation unit calculating a location of an end of said strip in width-wise and height-wise directions thereof, based on an image resulted from a light irradiated from said strip and an image resulted from a light irradiated from said second light-source and reflected at said strip.

11. The apparatus as set forth in claim 10, wherein a difference between said entrance angle and said incident angle is in the range of 5 degrees and 75 degrees both inclusive.

12. The apparatus as set forth in claim 10, wherein one of said second-light source and said camera is oriented perpendicularly to a surface of said strip.

13. The apparatus as set forth in claim 10, wherein said second light-source irradiates a light having a brightness greater than the same of a light irradiated from said strip.

14. The apparatus as set forth in claim 10, wherein said second light-source irradiates a light having a wavelength different from the same of a light irradiated from said strip, and
said camera is able to take a colored photo.

15. The apparatus as set forth in claim 1, wherein said camera is oriented perpendicularly to a surface of said strip.

16. The apparatus as set forth in claim 1, wherein said calculation unit calculates a location of an end of said strip in a width-wise direction thereof, based on an intersection of a boundary line between a bright area and a dark area in an image resulted from said first light-source or said strip, with a linear image resulted from said second light-source.

17. The apparatus as set forth in claim 1, wherein said calculation unit calculates a height of an end of said strip in accordance with a distance between a linear image resulted from said second light-source when said strip is running at a reference height and an actually obtained linear image.

18. The apparatus as set forth in claim 1, wherein said camera comprises a two-dimensional camera.

19. A method of detecting an end of a strip in width-wise and height-wise directions, said strip being running in a direction with vertical motion, said method comprising:
a first step of irradiating a light onto said strip;
a second step of irradiating a linear light onto said strip in an area in which a light irradiated in said first step is irradiated onto said strip;
a third step of taking a photo of an area of said strip including an area in which said linear light irradiated in said second step is irradiated, with an incident angle different from an entrance angle of said linear light irradiated in said second step; and
a fourth step of calculating a location of an end of said strip in width-wise and height-wise directions thereof, based on an image resulted from said first step and an image resulted from said second step.

20. The method as set forth in claim 19, wherein a difference between said entrance angle and said incident angle is in the range of 5 degrees and 75 degrees both inclusive.

21. The method as set forth in claim 19, wherein one of irradiation of said linear light in said second step and taking a photo in said third step is carried out perpendicularly to a surface of said strip.

22. The method as set forth in claim 19, wherein a light is irradiated onto a lower surface of said strip in said first step.

23. The method as set forth in claim 22, further comprising a step of diffusing a light before it reaches said strip.

24. The method as set forth in claim 19, wherein a light is irradiated onto an upper surface of said strip in said first step.

25. The method as set forth in claim 24, further comprising a step of setting a light irradiated in said second step to have a brightness greater than the same of a light irradiated in said first step.

26. The method as set forth in claim 19, further comprising a step of setting a light irradiated in said second step to have a wavelength different from the same of a light irradiated in said first step.

27. The method as set forth in claim 19, wherein an end of said strip in a width-wise direction is calculated in said fourth step, based on an intersection of a boundary between a bright area and a dark area found in an image resulted from said first step, with a linear image resulted from said second step.

28. The method as set forth in claim 19, wherein an end of said strip in a height-wise direction is calculated in said fourth step, based on a distance between a linear image resulted from said second step when said strip is running at a reference height, and an actually obtained linear image.

29. A method of detecting an end of a strip in width-wise and height-wise directions, said strip spontaneously irradiating a light and being running in a direction with vertical motion, said method comprising:
a first step of irradiating a linear light onto an upper surface of said strip;
a second step of taking a photo of an area of said strip including an area in which said linear light irradiated in said first step is irradiated, with an incident angle different from an entrance angle of said linear light irradiated in said first step; and
a third step of calculating a location of an end of said strip in width-wise and height-wise directions thereof, based on an image resulted from said first step and an image resulted from said light irradiated from said strip.

30. The method as set forth in claim 29, wherein a difference between said entrance angle and said incident angle is in the range of 5 degrees and 75 degrees both inclusive.

31. The method as set forth in claim 29, wherein one of irradiation of said linear light in said first step and taking a photo in said second step is carried out perpendicularly to a surface of said strip.

32. The method as set forth in claim 29, further comprising a step of setting a light irradiated in said first step to have a brightness greater than the same of a light irradiated from said strip.

33. The method as set forth in claim 29, further comprising a step of setting a light irradiated in said first step to have a wavelength different from the same of a light irradiated from said strip.

34. The method as set forth in claim 29, wherein an end of said strip in a width-wise direction is calculated in said third step, based on an intersection of a boundary between a bright area and a dark area found in an image resulted from a light irradiated from said strip, with a linear image resulted from said first step.

35. The method as set forth in claim 29, wherein an end of said strip in a height-wise direction is calculated in said third step, based on a distance between a linear image resulted from said first step when said strip is running at a reference height, and an actually obtained linear image.

36. The apparatus as set forth in claim 10, wherein said camera is oriented perpendicularly to a surface of said strip.

37. The apparatus as set forth in claim 10, wherein said calculation unit calculates a location of an end of said strip in a width-wise direction thereof, based on an intersection of a boundary line between a bright area and a dark area in an image resulted from said first light-source or said strip, with a linear image resulted from said second light-source.

38. The apparatus as set forth in claim 10, wherein said calculation unit calculates a height of an end of said strip in accordance with a distance between a linear image resulted from said second light-source when said strip is running at a reference height and an actually obtained linear image.
